(19) United States
(12) Patent Application Publication
(10) Pub. No.: US 2006/0277720 A1
(43) Pub. Date: Dec. 14, 2006

(54) Hinge having fixedly engaged hinge means

(76) Inventor: Rainer Hoffman, Langenfeld (DE)

Correspondence Address: ROBERT W. BECKER & ASSOCIATES, 707 HIGHWAY 333, SUITE B, TIJERAS, NM, 87059-7507, US

(21) Appl. No.: 11/450,911

(22) Filed: Jun. 9, 2006

(30) Foreign Application Priority Data
Jun. 9, 2005 (DE) 20 2005 009 049.2

(51) Int. Cl. E05D 7/00

(52) U.S. Cl. 16/353; 16/221

(57) ABSTRACT

A hinge for connecting structural elements to one another, including two hinge leaves each having a receiver aligned with one another. The hinge leaves are to be secured to respective ones of the structural elements. A hinge pin is connected to one of the receivers and is adapted to be inserted into a bore of the other receiver. An arresting mechanism is formed on the hinge pin and/or in the bore, and enables insertion of the hinge pin into the bore yet prevents withdrawal of the hinge pin out of the bore.

The instant application should be granted the priority date of June 9, 2005 the filing date of the corresponding German patent application 20 2005 009 049.2.

### BACKGROUND OF THE INVENTION

The present invention relates to a hinge for connecting structural elements to one another in a fixedly engaged or interlocking manner. The hinge comprises a first and a second hinge leaf, each of which is adapted to be secured to respective ones of the structural elements that are to be connected to one another.

Such hinges are known in general from use, and also from DE 43 39 797 C1, for example in the form of an unhingeable hinge. The hinge pin, which is formed on one of the hinge leaves, can be inserted into a receiving bore provided on the other hinge leaf, or can be removed therefrom. Such hinges are used, for example, on switch cabinets for mounting doors and/or covers.

However, there are applications where following assembly by inserting the hinge pin that is formed on one of the hinge leaves into the bore of the receiving means of the other hinge leaf, a dismantling of the hinge is either no longer necessary or should not even be possible. It is therefore an object of the present invention to provide a hinge of the aforementioned general type whereby after conclusion of the assembly of the hinge, it is no longer possible to withdraw the hinge pin out of the associated bore.

### BRIEF DESCRIPTION OF THE DRAWINGS

This object, and other objects and advantages of the present invention, will appear more clearly from the following specification in conjunction with the accompanying schematic drawings, in which:

FIG. 1 is an exploded view of one exemplary embodiment of an inventive hinge;

FIG. 2 shows the hinge of FIG. 1 with the receiving means for the hinge pin being partially cut-away;

FIG. 3 shows the hinge of FIG. 2 having a hinge pin that is divided into two halves by a slot;

FIG. 4 shows the hinge of FIG. 2 having a hinge pin embodied with a plurality of segments that are movable in a resilient manner relative to one another;

FIG. 5 shows the hinge of FIG. 2 with a hinge pin that is provided with arresting catches;

FIG. 6 shows the hinge of FIG. 2 having a bore that is provided on the inner side with a knurling or corrugation;

FIG. 7 shows the hinge of FIG. 2 having arresting catches that on the inner side project into the interior of the bore;

FIG. 8 shows the hinge of FIG. 2 having a hinge pin that is provided with a knurling or corrugation on its outer periphery; and

FIG. 9 shows the hinge of FIG. 2 having a hinge pin that is embodied as a separate component and is insertable into the receiving means of its hinge leaf.

### SUMMARY OF THE INVENTION

The hinge of the present application for connecting structural elements to one another comprises a first hinge leaf and a second hinge leaf, each of which has a receiving means, which are adapted to be aligned with one another, wherein the hinge leaves can be secured to respective ones of the structural elements that are to be connected to one another via the hinge; a hinge pin is connected to one of the receiving means and is adapted to be inserted into a bore of the other of the receiving means for interconnecting the receiving means and hence the hinge leaves; and arresting means are formed on the hinge pin and/or in the bore, wherein the arresting means enable insertion of the hinge pin into the bore, yet prevent withdrawal of the hinge pin out of the bore.

The present invention has the advantage that the arresting means, which are provided on the hinge pin or the bore or on both of these components that interengage one another, prevents a later withdrawal of the hinge pin. A dismantling of the hinge that is embodied in the manner described in the present application is possible only by unscrewing one of the associated hinge leaves from the associated structural element.

Pursuant to one embodiment of the present application, to provide the arresting means the hinge pin is provided in the direction of its longitudinal axis with a succession of substantially spherical elements having a diameter that decreases in a direction toward the insertion end of the hinge pin; the bore of the receiving means of the second hinge leaf is provided on the inner side with substantially spherical recesses for surrounding the spherical elements of the hinge pin when inserted into the bore in a positively engaging or interlocking manner.

Upon insertion of the hinge pin into the bore, the spherical elements having the initially smallest diameter and disposed at the forward insertion end of the hinge pin can pass the recesses disposed at the insertion end of the bore and having the initially greatest diameter until after the insertion of the hinge pin into the bore has continued, the spherical elements of the hinge pin and the recesses of the bore, the diameters of which are coordinated with one another, interengage or arrest one another. In this end position, it is no longer possible to withdraw the hinge pin out of the bore.

For this purpose, the hinge pin can be comprised of spheres that are monolithically interconnected as viewed in the longitudinal direction of the hinge pin; alternatively, the spherical elements of the hinge pin can each extend over a partial periphery of the hinge pin.

To avoid resistance to insertion, and to improve the arresting effect, the hinge pin can be divided by at least one slot that extends in the longitudinal direction of the hinge pin into two halves that are movable in a resilient manner relative to one another. In this way, during insertion of the hinge pin into the bore the two halves of the hinge pin can be pressed together, while after having achieved the final assembled position the two halves again spread apart, so that the spherical elements are accommodated in the recesses of the bore.

Alternatively, pursuant to a modification of the embodiment previously described, the hinge pin can be segmented in the longitudinal direction thereof so as to be provided with a plurality of segments that are movable in a resilient manner relative to one another.

Pursuant to another embodiment of the present application, for the formation of the arresting means, radially projecting arresting hooks, catches or detents are disposed on the hinge pin over the insertion length thereof; in the direction of insertion, the arresting catches are resiliently flexible relative to the longitudinal axis of the hinge pin. The bore of the receiving means is provided on the inside with a knurling or corrugation for a positive engagement of the arresting catches when the hinge pin is inserted. Due to the resilient arrangement of the arresting catches, the latter provide no resistance during the insertion of the hinge pin, yet when the hinge pin is subjected to a pulling load for the purpose of withdrawing the hinge pin, the arresting catches spread out radially and are arrested with the knurling or corrugation that is formed on the inner side of the bore, thereby preventing withdrawal of the hinge pin.

Alternatively, the reverse situation can be provided, in other words, the arresting catches can be formed in the bore and the knurling or corrugation can be provided on the hinge pin.

Pursuant to alternative embodiments of the present application, the hinge pin can either be a monolithic component of the receiving means that is formed on the hinge leaf, or it can be embodied as a separate component that can be connected to the receiving means of the hinge leaf.

Further specific features of the present application will be described in detail subsequently.

### Description of Specific Embodiments

Referring now to the drawings in detail, the illustrated hinge is comprised of a first hinge leaf 10 having a receiving means 11, and a hinge pin 12 that is monolithically or otherwise connected to the receiving means 11. In conformity therewith, the other or second hinge leaf 13 has a receiving means 14 that is adapted to be aligned with the receiving means 11 of the first hinge leaf 10; a bore 15 for receiving the hinge pin 12 is formed in the receiving means 14. Both of the hinge leaves 10 and 13 are provided with screw holes 16 for receiving non-illustrated fastening means by means of which the two hinge leaves 10 and 13 can be secured to structural elements that are to be connected to one another via the hinge, for example the frame and the door of a switch cabinet.

To prevent a dismantling of the hinge pin 12 following insertion of the hinge pin into the bore 15, in the illustrated embodiment the hinge pin 12 is comprised of substantially spherical elements 17 that are monolithically interconnected in the longitudinal axis of the pin; the diameter of the spherical elements 17 decrease in the direction of the insertion end of the hinge pin 12.

In conformity with the configuration of the hinge pin 12 with the spherical elements 17, the bore 15 has substantially spherical recesses 18 formed in its inner wall; each recess 18 is associated with a respective spherical element 17 of the hinge pin 12. Starting at the insertion end of the bore 15, the diameter of the recesses 18 decreases in a direction toward the deepest end of the bore 15, whereby the correspondence with regard to the configuration of the recesses 18 is such that when the hinge pin 12 is inserted, each spherical element 17 is disposed in the associated recess 18 and is surrounded thereby in a positive or form-locking manner.

Due to the diameter ratios that are selected, it is possible to insert the hinge pin 12 into the bore 15, whereby prior to reaching the end position, it is necessary to surmount each of the projecting portions 19 that are disposed ahead of the recesses 18 of the bore 15 that when the hinge is assembled receive the associated spherical elements 17 of the hinge pin 12; these projecting portions 19 separate the respected individual recesses 18 from one another. Once the hinge pin 12 has reached its end position in the bore 15, the spherical elements 17 are disposed in the associated recesses 18. In this connection, the projecting portions 19, which engage between the individual spherical elements 17 of the hinge pin 12 and separate the recesses 18 from one another, bring about an arresting of the hinge pin 12 in the bore 15 that can no longer be released.

In the embodiment illustrated in FIG. 3, the hinge pin 12 is divided by a slot 20, which extends in the longitudinal direction of the hinge pin, into two halves that are movable in a resilient matter relative to one another.

In the embodiment illustrated in FIG. 4, the hinge pin 12 is segmented in the longitudinal direction by the provision of a plurality of slots so as to be configured with a plurality of segments 22 that are movable in a resilient manner relative to one another.

As can be seen from the embodiment illustrated in FIG. 5, the arresting means can be formed by radially projecting arresting hooks, catches or detents 23 that are disposed on the hinge pin 12 over the insertion length thereof, and which are resiliently flexible in the direction of insertion relative to the longitudinal axis of the hinge pin 12.

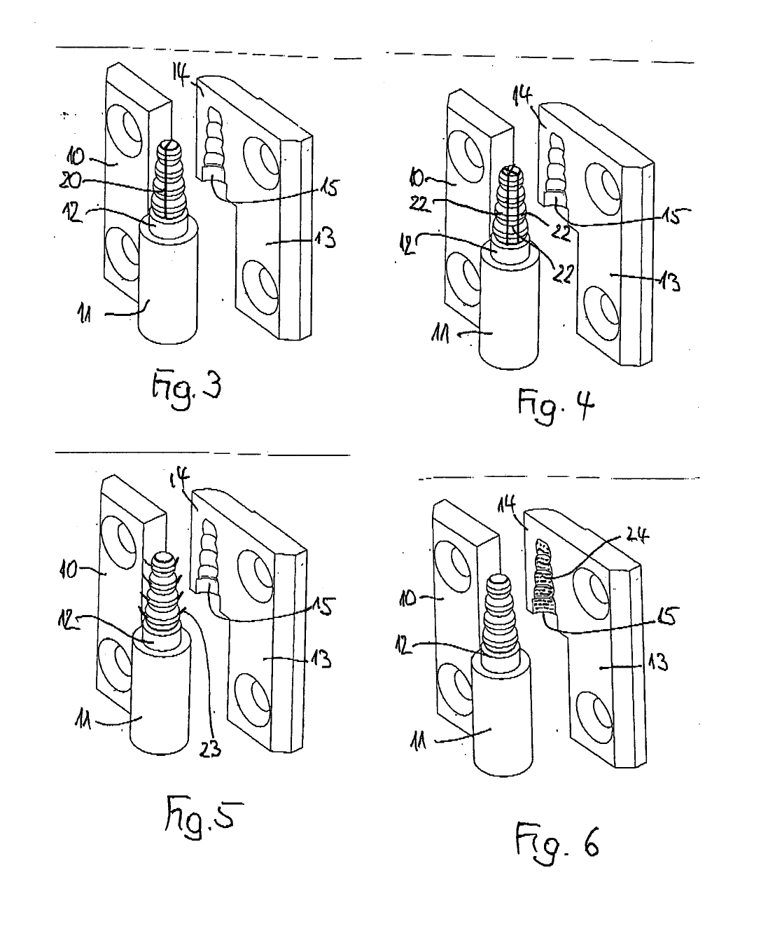

In the embodiment illustrated in FIG. 6, the bore 15 of the receiving means 14 is provided on the inside with a knurling or corrugation 24 for a positive engagement of the arresting catches 23 or spherical elements 17 when the hinge pin 12 is inserted.

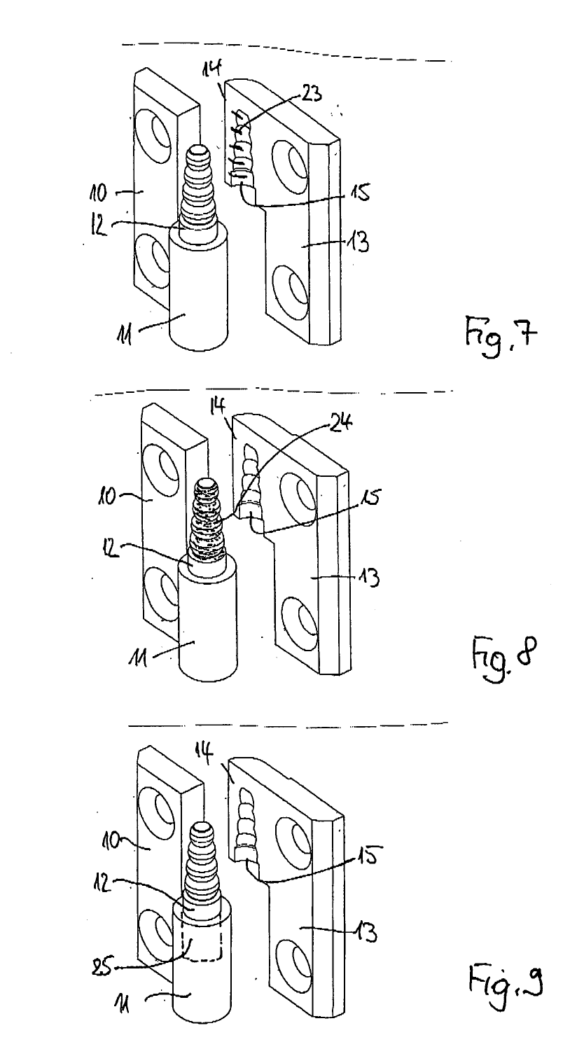

In the embodiment illustrated in FIG. 7, the arresting means are furthermore formed by arresting catches 23 that are disposed on the inner side of the bore 15 of the receiving means 14 and that project radially into the interior of the bore 15 and are resiliently flexible in the direction of insertion relative to the longitudinal axis of the bore 15.

In the embodiment illustrated in FIG. 8, the outer periphery of the hinge pin 12 is provided with a knurling or corrugation 24 for the positive engagement of the arresting catches 23 or spherical recesses 18 when the hinge pin 12 is inserted into the bore 15.

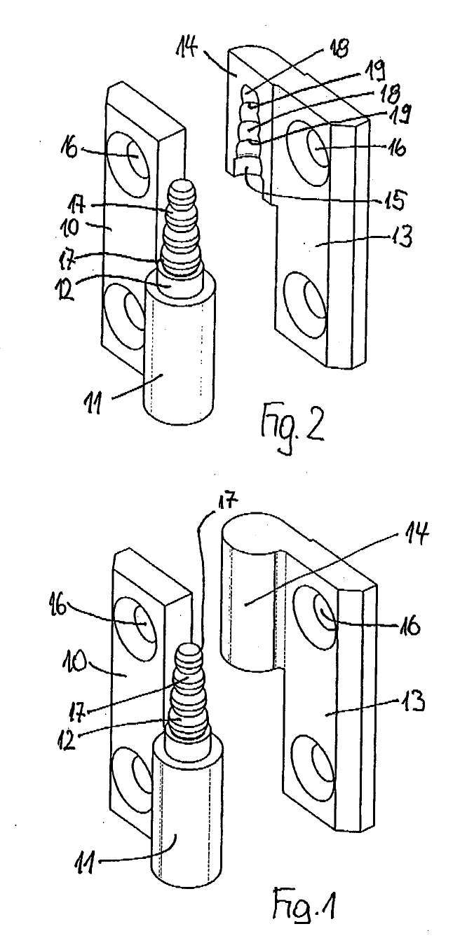

As an alternative to the monolithic connection between the hinge pin 12 and the receiving means 11 of the first hinge leaf 10 as illustrated in FIG. 2, pursuant to the embodiment of FIG. 9 the hinge pin 12 is embodied as a separate component that via an insertion pin 25 can be inserted into a corresponding bore of the receiving means 11; the hinge pin 12 could also be secured to the receiving means 11 in any other suitable manner, such as by means of a screw connection.

The features of the subject matter of this application disclosed in the preceding description, the claims and the drawings can be important individually as well as in any desired combination with one another for realizing the various embodiments of the invention.

The specification incorporates by reference the disclosure of German priority document 20 2005 009 049.2 filed Jun. 9, 2005.

The present invention is, of course, in no way restricted to the specific disclosure of the specification and drawings, but also encompasses any modifications within the scope of the appended claims.

What I claim is:

1. A hinge for connecting structural elements to one another, comprising:
a first hinge leaf having a receiving means;
a second hinge leaf having a receiving means, wherein said receiving means of said first hinge leaf and said receiving means of said second hinge leaf are adapted to be aligned with one another, and wherein said first and second hinge leaves are adapted to be secured to respective ones of the structural elements that are to be connected to one another via said hinge;
a hinge pin connected to one of said receiving means and adapted to be inserted into a bore of the other one of said receiving means for interconnecting said receiving means and hence said hinge leaves; and
arresting means formed on said hinge pin and/or in said bore, wherein said arresting means enable insertion of said hinge pin into said bore, yet prevent withdrawal of said hinge pin out of said bore.

2. A hinge according to claim 1, wherein said hinge pin is connected to said receiving means of said first hinge leaf, wherein said arresting means comprise a succession of substantially spherical elements that are disposed on said hinge pin in a direction of a longitudinal axis thereof, wherein said spherical elements decrease in diameter in a direction toward an insertion end of said hinge pin, and wherein said arresting means further comprises substantially spherical recesses provided on an inner surface of said bore of said receiving means of said second hinge leaf for surrounding said spherical elements in a positively engaging manner upon insertion of said hinge pin into said bore.

3. A hinge according to claim 2, wherein said spherical elements are monolithically interconnected in a longitudinal direction of said hinge pin.

4. A hinge according to claim 2, wherein said spherical elements of said hinge pin respectively extend over a partial periphery of said hinge pin.

5. A hinge according to claim 1, wherein said hinge pin is provided with at least one slot that extends in a longitudinal direction of said hinge pin and divides it into two halves that are movable in a resilient manner relative to one another.

6. A hinge according to claim 1, wherein said hinge pin is segmented in a longitudinal direction of said hinge pin by means of a plurality of segments that are movable in a resilient manner relative to one another.

7. A hinge according to claim 1, wherein said arresting means include arresting catches that are disposed in a radially projecting manner on said hinge pin over an insertion length thereof, and wherein in a direction of insertion of said hinge pin, said arresting catches are resiliently flexible relative to a longitudinal axis of said hinge pin.

8. A hinge according to claim 7, wherein said arresting means further comprise a knurling or corrugation disposed on an inner surface of said bore of said receiving means of said second hinge leaf for a positive engagement of said arresting catches upon insertion of said hinge pin into said bore.

9. A hinge according to claim 1, wherein said arresting means include arresting catches that are provided on an inner surface of said bore of said receiving means of said second hinge leaf (that project radially into the interior of said bore, and wherein in a direction of insertion of said hinge pin into said bore said arresting catches are resiliently flexible relative to a longitudinal axis of said bore.

10. A hinge according to claim 9, wherein said arresting means further include a knurling or corrugation on an outer periphery of said hinge pin for a positive engagement with said arresting catches upon insertion of said hinge pin into said bore.

11. A hinge according to claim 1, wherein said hinge pin is monolithically formed with said receiving means of said first hinge leaf.

12. A hinge according to claim 1, wherein said hinge pin is a separate component that is adapted to be connected with said receiving means of said first hinge leaf.
